(19) United States
(12) Patent Application Publication
(10) Pub. No.: US 2006/0082205 A1
(43) Pub. Date: Apr. 20, 2006

(54) Sleeping Aid

(76) Inventor: Brenda S. Hobson, Harwood, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 10/710,520

(22) Filed: Jul. 18, 2004

(51) Int. Cl. B60R 22/10

(52) U.S. Cl. 297/393

(57) ABSTRACT

A hat with hook and loop type fastener that attaches to a second piece of hook and loop type fastener that is situated on the flat back area of a car seat, child carrier device, wheel chair or any other restraint device used to transport infants, larger children or physically challenged individuals. The present invention provides the user with support so that their heads do not slump when they fall asleep in car seats, child carrier devices, or wheel chairs. Using the present device will prevent discomfort, muscle strain, or other physical symptoms caused by the inability to control neck muscles. The present invention also provides support as a safety device when the child is sleeping, because it will hold the user's head in place. The present invention can also be used for adults as well as infants, children, elderly and physically challenged individuals. The present invention can be used on any automobile car seat or wheel chair, it is easily transported, lightweight, washable and convenient to use.

### BACKGROUND OF INVENTION

The present invention is a sleeping aid for use in moving vehicles, and more particularly, is a fastening system that prevents the user's head from dropping into awkward positions when the user falls asleep in an upright seated position.

Twenty years ago, before the advent of mandatory car seats and seatbelts, adults and children found it rather simple to sleep in an automobile. For example, sleeping on a long trip meant stretching out on a back seat or even in the rear of a station wagon.

Nowadays, sleeping in a car is not so easy. An adult sleeping in the backseat should remain in an upright seated position with a seatbelt firmly fastened. This is problematic because once the adult falls asleep, the adult wants to lie down on the backseat, but cannot. The fastened seatbelt holds the adult upright, and the adult's head simply hangs from the adult's neck. As the car turns right and left, or slows and accelerates, the adult's head is tossed to and fro, causing neck strain and eventually discomfort.

A child sleeping in the backseat should remain in an upright seated position in a booster seat with a seatbelt firmly fastened. This is problematic because once the child falls asleep, the child wants to lie down on the backseat, but cannot. The fastened seatbelt holds the child upright, and the child's head simply hangs from the child's neck. As the car turns right and left, or slows and accelerates, the child's head is tossed to and fro, causing neck strain and eventually discomfort.

Very young children and babies typically sit in car seats that partially recline. Further, very young children and babies typically sit in car seats that have cushioned braces alongside the space for the very young children's and babies' heads. Thus, very young children and babies are conditioned to sleep in a car without worrying about supporting their neck while asleep since the car seat already reclines and has braces to do such. When a transition is made to a booster seat, the former very young children and babies are in no way prepared for the sudden lack of recline or braces for their heads. In addition, some car seats do not adequately prevent a sleeping child's head from dropping forward and/or moving to and fro.

Thus there is a pressing need for a means for preventing the heads of children and adults from tossing to and fro when the children and adults fall asleep. Such a means must be simple to use, incapable of being defeated by children once engaged, and relatively inexpensive to achieve mass market acceptance. There have been a variety of devices proposed in relevant art in an attempt to solve these problems. However, there are various drawbacks associated with prior art.

U.S. Pat. No. 5,383,711 issued to Houghteling on Jan. 24, 1995, is a head support device that supports the head of an infant, but unlike the present invention it restricts the side vision of the infant, and it can only fit into certain shaped infant seats, which makes it incompatible with some types of restraining devices. Moreover, it is not suitable for older children and adults as a means for preventing the their heads from tossing to and fro when sleeping upright in a vehicle.

U.S. Pat. No. 4,779,930 issued to Rosen on Oct. 25, 1988, in an infant head support device, but it can only be used for supporting the heads of infants and early age children. Unlike the present invention, it cannot be used to support the heads of older children or adults.

Japanese Patent Publication Serial No. JP2003025884A2 invented by Irabe Mitsuhiro published on Jul. 16, 2001, is a passenger car seat and head-protecting band for a child seat that actually wraps around the circumference of the child's head. In Mitsuhiro's device, the child's head is held attached to a strip of material that can sway to and fro, so that although the child's head is prevented from some movement, movement will still occur. Moreover, unlike the present invention, Mitsuhiro's device is easily accessible by a child, such that the child can simply remove the loop around the child's head to disable Mitsuhiro's device, unlike the present invention.

Japanese Patent Publication Serial No. JP2002291570A2 invented by Sakuma Miyoshi published on Mar. 31, 2001, is a head supporter for an infant to be used in a vehicle. Miyoshi's device can only be used in conjunction with a vehicle passenger seat that has specified holes in the top seatback, and this limits the compatibility to many types of car booster seats, and cars as well. Unlike the present invention, if a center back seat, for example, lacks a top seatback, then Miyoshi's device cannot be installed. Further, Miyoshi's device assumes that the child is tall enough fit within it since it attaches at the top of the conventional seat of a car. Moreover, Miyoshi's device does not prevent forward motion of an adult's or child's head.

Numerous other patents of relevant art exist, however, they do not offer the features and benefits of the present invention and have drawbacks such as: being incompatible with other devices, being unduly restrictive regarding the movement of the users, being restricted to small children, being hard to move between various restraints, and being obstructions to the user's view. Therefore, despite the attempts made by the relevant art, there still exists a need for a device to stabilize and support the head and neck of a booster seat age child or adult while sleeping during travel in a motor vehicle. The relevant art, taken alone or in combination, does not offer a solution to the current problem, as does the present invention.

### SUMMARY OF INVENTION

The present invention provides head support for children and adults when they fall asleep in a moving vehicle. Rather than allowing the children's and adults' heads to fall forward or side to side, the present invention provides instantaneous and resilient holding of the children's and adults' heads so that sleep is made easy. The head support of the present invention may be also utilized by adults while traveling on trains, busses, cars, airplanes or it can also be used with physically challenged children and adults that do not have adequate muscle control to support their heads.

The present invention is portable and can easily be transferred between cars, car seats, infant carriers, strollers, wheel chairs and other transporting devices. The present invention can be used for various ages of users. The hat or any headwear will be a conventional hat, or head covering made of fabric that fits snuggly on the head. The fabric used for the hat will have the necessary combination of elasticity; combining knit, polyester, Lycra™ and other appropriate fabric to ensure a comfortable, snug fit on the head of the user. A piece of hook and loop type fastener will be attached to the back of the cap and a corresponding piece of hook and loop type fastener will be attached to the flat surface of the car seat. The user's head will be placed into the cap and then the two pieces of hook and loop type fasteners are connected and will remain connected for as long as necessary. While the user has the cap on its head, the two pieces of hook and loop type fastener will hold the user's head in a supported and secured position.

### BRIEF DESCRIPTION OF DRAWINGS

FIG. 1 shows a conventional child's car seat with the hook and loop type fastener attached to the flat back surface of the car seat.

FIG. 2 shows a slight profile of a child wearing a conventional hat with the present invention attached across the back of the hat.

FIG. 3 shows a conventional hat with the hook and loop type fastener attachment attached to the hat.

### DETAILED DESCRIPTION

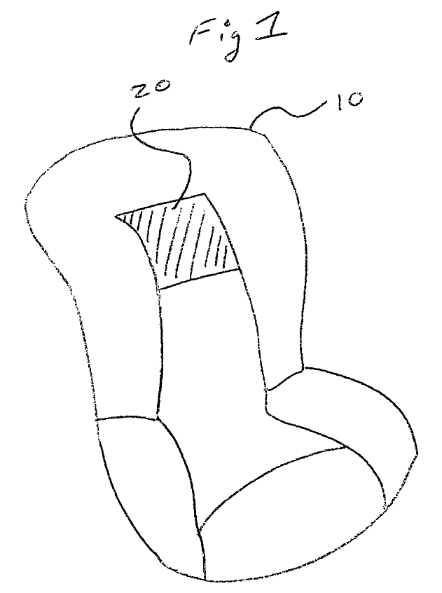

Turning to FIG. 1, a conventional car seat 10 is shown with the first member hook and loop type fastener 20 shown attached to the front surface of the conventional car seat 10. The first member hook and loop type fastener 20 is placed toward the top of the conventional car seat 10 at the point where the head of the user conventionally rests.

In the preferred embodiment, the first member hook and loop type fastener 20 will cover a great portion of the back of the conventional car seat 10 or in an alternative embodiment, the first member hook and loop type fastener 20 can be placed along the back of the car seat depending on the height, placement and position of the child in the conventional car seat 10 or other carrying device and the position of the child's head.

Once the hat 40 has been placed onto the head of the sleeping user or a user that has no control of their neck muscles, and contact between the first member hook and loop type fastener 20 and the second member hook and loop type fastener 30, the user's head will remain steady in the supported position. The user's head will not slump, tilt or roll from side to side as the user sleeps or is otherwise engaged. If the user wakes up or chooses to change positions, they will be able to turn their head and their heads will rotate inside the hat 40 while connection between first member hook and loop type fastener 20 and the second member hook and loop type fastener 30 are still engaged.

In an alternative embodiment, where a lesser strength hook and loop type fastener is used, the user who has the ability to control their neck muscles or they have significant strength control their heads will be able to pull and or lift their heads and disengage the second member hook and loop type fastener 30 from the first member hook and loop type fastener 20. The user will be able to resume the general movement of their head and neck.

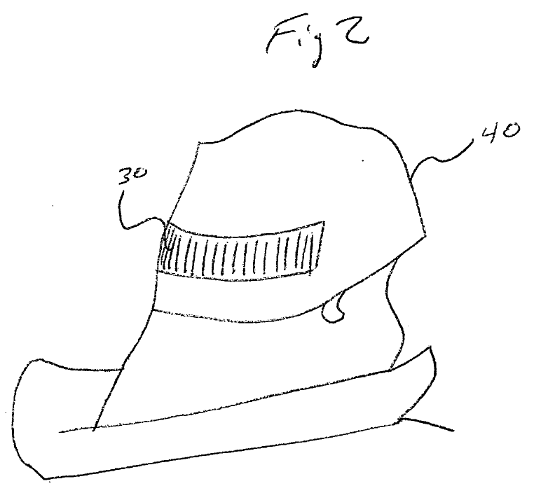

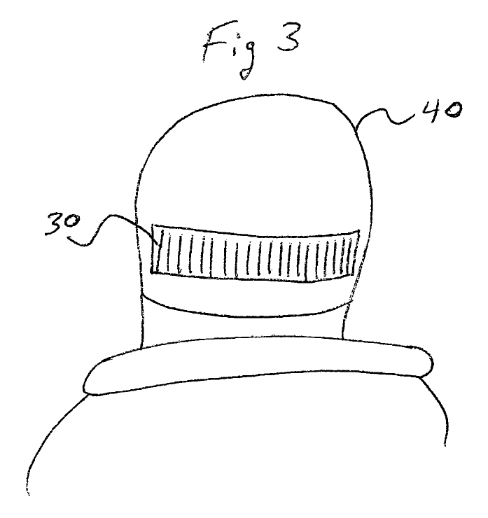

In FIG. 2, a child is shown from a slight side view and the second member hook and loop type fastener 20 is shown attached to the hat 40. This view shows that the second member hook and loop type fastener 20 extends across the back of the hat 40. FIG. 3 shows a back view of a child wearing a hat 40 with the second member hook and loop type fastener 20 extending across the back of the hat 40.

The present invention should be construed to not be just the embodiments described above, but additionally, to be any and all embodiments within the scope of the following claims.

1. A device for maintaining a user's head against a seatback, comprising:
a hat configured to receive the user's head, but to allow the user's head to rotate within said hat;
a first piece of hook and loop type fastener, in communication with said hat; and
a second piece of hook and loop type fastener, in communication with said first piece of hook and loop type fastener, configured to attach to the seatback.

2. (canceled)

3. (canceled)

4. The device of claim 1, wherein said first piece of hook and loop type fastener and said second piece of hook and loop fastener are configured to separate from one another under conscious movement of the user's head.

5. A device for maintaining a user's head against a seatback, comprising:
a hat;
a first piece of hook and loop type fastener, in communication with said hat; and
a second piece of hook and loop type fastener, in communication with said first piece of hook and loop type fastener, configured to attach to the seatback;
wherein said first piece of book and loop type fastener and said second piece of hook and loop fastener are configured to separate from one another under conscious movement of the user's head.
